(19) United States
(12) Patent Application Publication
(10) Pub. No.: US 2024/0083202 A1
(43) Pub. Date: Mar. 14, 2024

(54) METHOD FOR OPERATING A MONITORING DEVICE FOR AT LEAST ONE VEHICLE PARAMETER

(71) Applicant: Robert Bosch GmbH, Stuttgart (DE)

(72) Inventors: Christian Reichert, Nuertingen (DE); Joachim Nagel, Reutlingen (DE); Juergen Class, Winnenden (DE); Ouael Hajji, Stuttgart (DE)

(21) Appl. No.: 18/548,737

(22) PCT Filed: Feb. 3, 2022
(86) PCT No.: PCT/EP2022/052521

§ 371 Date: Sep. 27, 2023

(30) Foreign Application Priority Data
Mar. 4, 2021 (DE) 10 2021 202 101.8

(51) Int. Cl. B60C 23/04

(52) U.S. Cl. CPC B60C 23/0454; B60C 23/0459; B60C 23/0461; B60C 23/0479

(57) ABSTRACT

A method for operating a monitoring device for at least one vehicle parameter, in particular an air-pressure sensor for the tire-pressure vehicle parameter. The monitoring device is operated in a drive mode or in a stationary mode as a function of the velocity of the vehicle. Connection signals for the wireless connection to an external device, in particular a configuration device for the monitoring device, are transmitted in the stationary mode. Prior to the change to the stationary mode, the monitoring device is operated in a first intermediate mode. A passive search for wireless connection signals from the external device is carried out in the first intermediate mode.

### FIELD

The present invention relates to a method for operating a monitoring device for at least one vehicle parameter, in particular a tire-pressure monitoring system for the tire-pressure vehicle parameter.

In addition, the present invention relates to a monitoring device for at least one vehicle parameter of a vehicle, in particular a tire-pressure monitoring system for the tire-pressure vehicle parameter.

### BACKGROUND INFORMATION

Although all kinds of monitoring devices can be used as a matter of principle, the present invention is described with reference to tire-pressure control systems, also known as tire pressure monitoring systems—TPMS.

Tire-pressure control systems are used for monitoring the tire pressure in motor vehicles in order to prevent accidents caused by an incorrect tire pressure. Using the optimal tire pressure adapted to the individual vehicle, it is possible to reduce both the fuel consumption and tire wear. Tire-pressure control systems are able to detect a change in the air pressure in the respective tire both actively with the aid of electronic pressure sensors that transmit the tire pressure and an identification via radio to a control device at certain time intervals, and passively based on a change in the rolling circumference and based on a change in a characteristic vibration frequency of the respective wheel.

The tire-pressure control system is able to be operated not only in a drive mode, i.e., when the vehicle is in motion and the air pressure must be actively monitored, but also in a stationary mode when the vehicle is standing still, e.g., for repair purposes. In the stationary mode, the tire-pressure control system attempts to connect to an external maintenance device. Since the stationary mode is also assumed in the event of a standstill of the vehicle in a traffic jam or the like, all sensors of every vehicle then attempt to establish a corresponding connection to an external maintenance device by emitting connection information, which leads to overloading of the corresponding radio frequencies and also wastes energy.

### SUMMARY

In one example embodiment, the present invention provides a method for operating a monitoring device for at least one vehicle parameter, in particular a tire-pressure monitoring system for the tire-pressure vehicle parameter, the monitoring device being operated in a drive mode or in a stationary mode as a function of the velocity of the vehicle, and connection signals for the wireless connection to an external device, in particular a configuration device for the vehicle system, are emitted in the stationary mode, and prior to the change to the stationary mode, the vehicle system is operated in a first intermediate mode, in which a passive search for wireless connection signals from the external device takes place.

In a further embodiment, the present invention provides a monitoring device for at least one vehicle parameter of a vehicle, in particular a tire-pressure monitoring system for the tire-pressure vehicle parameter, the monitoring device being operable in a drive mode or in a stationary mode as a function of the velocity of the vehicle, and the monitoring device is designed to emit connection signals for the wireless connection to an external device in the stationary mode, in particular a configuration device for the vehicle system, and can be operated in a first intermediate mode prior to a change to a stationary mode, and a passive search for wireless connection signals from an external device is carried out in the first intermediate mode.

In a further embodiment, the present invention provides a vehicle equipped with a monitoring device.

One of the advantages achieved in this way is that energy is saved. A further possible advantage is that jamming, or in other words, overloading of the corresponding frequency range by the output of connection messages or connection signals during the change from the drive mode to the stationary mode, is avoided.

The wording ‘passively searching’ is to be understood in its broadest sense, and relates to an operating state in which signals are able to be received but no own signals are emitted for establishing a connection.

The wording ‘external device’ should be understood in its broadest sense, and relates to any device outside the monitoring device. An ‘external device’ is particularly not restricted to devices outside a vehicle but also relates to devices inside a vehicle. Additional features, advantages and further embodiments of the present invention are described in the following text or are disclosed thereby.

According to an advantageous refinement of the present invention, the change from the drive mode to the first intermediate mode takes place when a drop below a first velocity threshold value has occurred, the change from the drive mode to the first intermediate mode in particular being implemented at a standstill of the vehicle, and the change from the first intermediate mode to the drive mode being implemented when a second vehicle velocity threshold is exceeded, the two velocity threshold values preferably differing and the second velocity threshold value preferably being greater than the first velocity threshold value. One of the advantages achieved in this way is that a simple and rapid change to the first intermediate mode is able to take place. At the same time, for instance when the vehicle is stuck in a traffic jam, a change back to the drive mode takes place only once a corresponding threshold value in the upward direction is exceeded. Two threshold values that are independent of each other and may possibly also be adaptable increase the flexibility.

According to a further advantageous refinement of the present invention, the change from the first intermediate mode to the stationary mode takes place after a predefined time interval has elapsed, in particular if no external device was detected during the time interval. This has the advantage that the monitoring device is operated in the stationary mode and actively emits connection signals only after a longer standstill of the vehicle in an effort to connect to the external device.

According to a further advantageous refinement of the present invention, if an external device is detected in the first intermediate mode, a change to a second intermediate mode is implemented and the monitoring device outputs connection signals for establishing a wireless connection to the detected external device. As a result, a simple and reliable connection is enabled between the monitoring device and the external device.

According to a further advantageous refinement of the present invention, if no wireless connection to the detected external device has been established in the second intermediate state after a predefined time interval has elapsed, especially during the time interval, a change from the second intermediate state to the first intermediate state takes place. This offers the advantage that the passive search for an external device is continued without a direct change to the stationary mode. Thus, if the external device was not in range or was only briefly in range, for example, a connection can still be established once the external device is brought in range of the monitoring device again.

According to a further advantageous refinement of the present invention, if an established wireless connection of the monitoring device to the external device has been interrupted and/or terminated, in particular following a predefined time interval, and no further data were preferably transmitted between the external device and the monitoring device during this time interval, a change to the stationary mode is implemented. As a result, unnecessary (repeat) connection attempts are avoided, which saves energy.

According to a further advantageous refinement of the present invention, the transmission power of the monitoring device is at least intermittently reduced in the second intermediate state when connection signals are emitted for a connection to the external device. This makes it possible to ensure that the external device is in the vicinity of the monitoring device so that a reliable connection to the external is able to be established.

According to a further advantageous refinement of the present invention, identification data of a detected external device, in particular a MAC-ID, are stored in the first intermediate state and utilized accordingly in the second intermediate state when the wireless connection with the external device is established. This is advantageous for a simple and rapid connection between an external device and a monitoring device.

According to a further advantageous refinement of the present invention, the wireless connection is based on Bluetooth, in particular on the Bluetooth low-energy radio technology. This provides a cost-effective and simple and also reliable wireless connection.

Additional important features and advantages of the present invention result from the disclosure herein.

It is understood that the afore-mentioned features and the features still to be described in the following text are able to be used not only in the respective indicated combination but also in other combinations or on their own without departing from the scope of the present invention.

Preferred embodiments and embodiments of the present invention are shown in the drawings and will be described in greater detail in the following description, where identical reference numerals relate to identical or similar or functionally equivalent components or elements.

### BRIEF DESCRIPTION OF THE DRAWINGS

FIG. 1 shows steps of a method according to an example embodiment of the present invention.

FIG. 2 shows a system according to an embodiment of the present invention.

### DETAILED DESCRIPTION OF EXAMPLE EMBODIMENTS

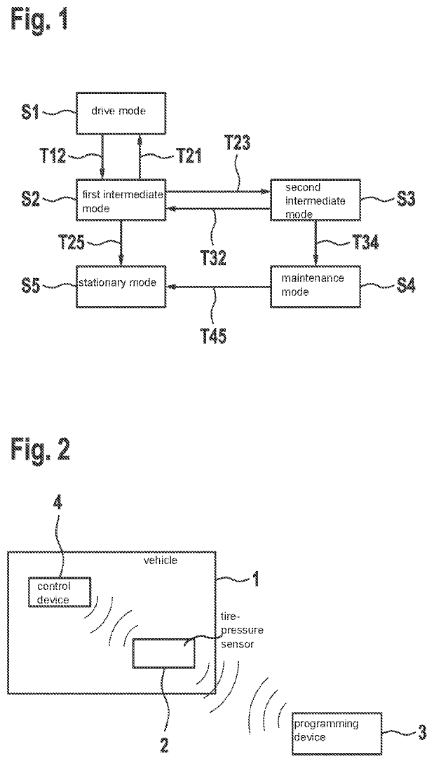

FIG. 1 schematically shows steps of a method according to an embodiment of the present invention, and FIG. 2 shows a system according to an embodiment of the present invention.

More specifically, FIG. 1 shows different operating states of a monitoring device according to an embodiment of the present invention. In the present case, the monitoring device is developed in the form of a tire-pressure sensor of a vehicle.

In drive mode S1, vehicle 1 is in motion, and the monitoring device in the form of a tire-pressure sensor 2 monitors the tire pressure in a tire of the vehicle. To this end, a wireless connection on the basis of the Bluetooth low-energy standard exists between tire-pressure sensor 2 and a control device 4 in vehicle 1, and tire-pressure sensor 2 continuously emits so-called advertisement indication frames by which the presence of tire-pressure sensor 2 is indicated to control device 4.

If the velocity of vehicle 1 is then reduced to 0 km/h, which means that vehicle 1 is at a standstill, a change T12 from drive mode S1 as the operating state of tire-pressure sensor 2 to a first intermediate mode S2 takes place. In first intermediate mode S2, tire-pressure sensor 2 now carries out a passive scan for an external device in the form of a programming device 3. The mentioned advertisement indication frames are no longer output. The passive scan is carried out until, for example, vehicle 1 is moving above a predefined velocity again, which amounts to 5 km/h in this case by way of example. A change T21 back to drive mode S1 of tire-pressure sensor 2 then takes place. If no programming device 3 is detected as a result of the passive scan in first intermediate mode S2 within a predefinable time interval, a change T25 to a stationary mode S5 will be carried out, in which tire-pressure sensor 2 emits advertisement indication frames.

If the presence of a programming device 3 is detected in first intermediate mode S2 as a result of the passive scan, then a change T23 to a second intermediate mode S3 is implemented, in which connection signals—connection advertisement frames—are now actively emitted by tire-pressure sensor 2 in order to establish a connection to the detected programming device 3. In this context, the detected programming device 3 is able to be identified with the aid of its MAC address, for instance. This MAC address is able to be stored in tire-pressure sensor 2 and later be used to establish the connection by outputting corresponding advertisement direct indications. The MAC address may also be checked when a connection request is received from a programming device 3. It is also possible to reduce the transmission power of tire-pressure sensor 2 in the second intermediate state while a connection is established so that it can be ensured that programming device 3 is in the immediate vicinity of tire-pressure sensor 2 and desired tire-pressure sensor 2 is able to be serviced.

If no connection is established to detected programming device 3 following a certain time interval, then a change T32 back to first intermediate mode S2 takes place. In contrast, if a connection with detected programming device 3 is established, then a change T34 of tire-pressure sensor 2 to a maintenance mode S4 is implemented, in which a connection to programming device 3 for maintenance purposes exists. To this end, programming device 3 transmits a corresponding connection request to tire-pressure sensor 2.

If the connection to programming device 3 is then terminated, for instance if the maintenance has been concluded or no data exchange takes place between programming device 3 and tire-pressure sensor 2 within a predefined time interval, then a change T45 to stationary mode S5 is implemented, in which tire-pressure sensor 2 once again outputs advertisement indication frames.

The basic principle of the afore-described method is based on the following profiles that are assumed by tire-pressure sensor 2 and programming device 3 during the mode changes. In this context, tire-pressure sensor 2 initially assumes a central role in that it carries out passive scans, and then changes to the decentralized role when a programming device 3 is detected. In contrast, programming device 3 starts out in the decentralized role and emits advertisement packets. Programming device 3 then changes to the central role in which it searches for connectable sensors 2 and then establishes a connection to these sensors.

Although the present invention has been described with the aid of preferred exemplary embodiments, it is not restricted to such but can be modified in a wide variety of ways.

1-11. (canceled)

12. A method for operating a monitoring device for at least one vehicle parameter of a vehicle, the method comprising:
operating the monitoring device in a drive mode or in a stationary mode as a function of a velocity of the vehicle;
emitting connection signals for wireless connection to an external device in the stationary mode;
prior to a change to the stationary mode, operating the monitoring device in a first intermediate mode, a passive search for wireless connection signals from the external device being performed in the first intermediate mode.

13. The method as recited in claim 12, wherein the monitoring device is an air-pressure sensor for a tire-pressure vehicle parameter.

14. The method as recited in claim 12, wherein the external device is a configuration device for the monitoring device.

15. The method as recited in claim 12, wherein a change from a drive mode to the first intermediate mode takes place when a drop below a first velocity threshold value occurs, a change from the drive mode to the first intermediate mode being implemented at a standstill of the vehicle, and a change from the first intermediate mode to the drive mode being implemented when a second velocity threshold value is exceeded, the first and second velocity threshold values differing from one another, and the second velocity threshold value being greater than the first velocity threshold value.

16. The method as recited in claim 12, wherein a change from the first intermediate mode to the stationary mode takes place after a predefined time interval has elapsed, when no external device was detected during the time interval.

17. The method as recited in claim 12, wherein when the external device is detected in the first intermediate mode, a change to a second intermediate mode is implemented, and the monitoring device outputs connection signals for establishing a wireless connection to the detected external device.

18. The method as recited in claim 17, wherein when no wireless connection to the detected external device has taken place in the second intermediate mode after a predefined time interval has elapsed, a change from the second intermediate mode to the first intermediate mode is implemented.

19. The method as recited in claim 12, wherein when an established wireless connection of the monitoring device to the external device is interrupted and/or terminated, following a predefined time interval during which no further data were transmitted between the external device and the monitoring device, a change to the stationary mode takes place.

20. The method as recited in claim 17, wherein in the second intermediate mode, transmission power of the monitoring device is at least intermittently reduced when connection signals are emitted for a connection to the external device.

21. The method as recited in claim 17, wherein in the first intermediate mode, identification data of a detected external device including a MAC-ID, are stored and utilized in the second intermediate mode when the wireless connection to the external device is initiated.

22. The method as recited in claim 12, wherein the wireless connection is based on a Bluetooth low-energy radio technology.

23. A monitoring device for at least one vehicle parameter of a vehicle, wherein the monitoring device is configured to operate in a drive mode or in a stationary mode as a function of a velocity of the vehicle, the monitoring device being configured to output connection signals in the stationary mode for a wireless connection to an external device, and prior to a change to the stationary mode, the monitoring device being configured to operate in a first intermediate mode, a passive search for wireless connection signals from the external device being performed by the monitoring device in the first intermediate mode.

24. The monitoring device as recited in claim 23, wherein the monitoring device is an air-pressure sensor for a tire-pressure vehicle parameter.

25. The monitoring device as recited in claim 23, wherein the external device is a configuration device for the monitoring device.

26. A vehicle, comprising:
a monitoring device for at least one vehicle parameter of the vehicle, wherein the monitoring device is configured to operate in a drive mode or in a stationary mode as a function of a velocity of the vehicle, the monitoring device being configured to output connection signals in the stationary mode for a wireless connection to an external device, and prior to a change to the stationary mode, the monitoring device being configured to operate in a first intermediate mode, a passive search for wireless connection signals from the external device being performed by the monitoring device in the first intermediate mode.
